(19) United States
(12) Patent Application Publication
(10) Pub. No.: US 2009/0096820 A1
(43) Pub. Date: Apr. 16, 2009

(54) Method and device for printing details onto a document

(76) Inventor: Peter Liebenau, Eurasburg (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 11/628,821

(22) PCT Filed: Jun. 4, 2005
(86) PCT No.: PCT/EP2005/006011

§ 371 Date: Aug. 26, 2008

(30) Foreign Application Priority Data
Jun. 7, 2004 (DE) 10 2004 027 678.1

(51) Int. Cl. H04N 1/034; G06K 1/00

(52) U.S. Cl. 347/3; 358/1.15

(57) ABSTRACT

The invention relates to a method for printing details onto a document, especially a passport, which comprises the following steps: a) detecting, by means of a first camera, two intersecting edges of the document; b) calculating the position of a first field of the document to be imprinted with a first detail using the position of the detected edges; c) positioning a print head on the first field to be imprinted and printing the first detail; d) detecting, by means of a second camera, a graphic element in the document; e) calculating the position of a second field to be imprinted using the position of the detected graphic element; f) positioning the print head on the second field to be imprinted and printing the second detail.

### FIELD OF THE INVENTION

The present invention relates to a method and a device for printing details into a document, in particular for printing bearer-specific details into a passport.

### BACKGROUND OF THE INVENTION

A passport is generally in the form of a bound notebook or small book, one page or two opposing pages has a preprinted legend that indicates what kind of details about the person holding the passport should be entered in various regions of the page that are designated by the legend.

Many applications exist in which individual details must be printed, correctly placed, in fields of a form that are intended for that purpose, such as in automatically creating preprinted remittance forms to be appended to an invoice by a bookkeeper. In that case, the invoice number, client number, and/or amount of the invoice, for instance, must each be placed correctly at a place on the form intended for it, without overlapping onto preprinted text or other graphic elements of the form. In the case of a substantially sheetlike form such as a remittance slip, this is comparatively simple to do, since when the form is produced, the pattern of the preprinted material can be placed with a certain tolerance relative to the edges of the sheet. For most applications, it therefore suffices if a printer used to fill out the preprinted form can detect the position of the edges of the form with adequate precision or can place edges of the form exactly in a predetermined position, so that given the knowledge of the position of the edges, the position of a field to be filled out can be calculated, and the intended detail can be printed into that field.

In principle, such a technique can also be used for printing details into a passport or other official document, as long as it is assured that the fields of the document that are to be filled out and that are defined by the preprinted form are always located in the same position, with sufficient precision, relative to the edges of the form. However, this requirement cannot always be met. One reason for this is the increasing density of information in a modern passport.

For instance, to improve the security against counterfeiting of official personal documents, consideration is being given to recording the various details about the person of the document bearer in such a document not only in a form that is detectable by the naked eye, but also in encoded form, so that counterfeiting can be detected by comparing the details that are detectable by the naked eye with those that are encoded. In international travel, for simplifying the process of checking persons and to speed it up, there is a need for at least some of the information about the person of the document bearer to be in a form that is optimized for machine reading. Although machine readability of the details does not necessarily preclude them from being readable with the naked eye, nevertheless it is seldom optimal for visual detection, and thus for the sake of rapid processing of the document, it is indispensable that the same details also be incorporated in a form that is optimized for reading by a human official. Efforts are furthermore being made to include additional biometric information about the bearer in a passport, although such information was not previously usual. Because of the large quantity of information that has to be accommodated, it is a requirement that the fields provided for imprinting this information be made no larger than absolutely necessary; in other words, the positional tolerance for printing the information into the fields is narrow.

Another factor is that, unlike forms made up of individual sheets, a passport, between the time when its sheets are imprinted with the preprinted material and when the bearer-specific information is entered into the fields of the preprinted form, must go through many processing steps, which make it difficult to position the fields of the preprinted form exactly relative to the edges of the passport. After being imprinted with the preprinted text, the sheets of the passport must be collated into a notebook, provided with a durable cover, and trimmed at the edges, in order to produce a blank passport. The position of the preprinted fields relative to the edges of the passport can therefore easily fluctuate by a few millimeters. Unless this fluctuation is compensated for when the passport is being filled out with the personal information about the passport bearer, it can happen that the personal information is printed on top of the preprinted legend. In that case, the personal information is readable only with difficulty, making the passport unusable.

It would admittedly be conceivable in principle to fix the position of the details to be imprinted into the passport by detecting a graphic element of the preprinted material, such as a word of the legend, and defining the position of the details to be imprinted relative to this graphic element. However, this again is not entirely satisfactory, since information to be imprinted near the edge of the page might be trimmed off. Machine reading of information in which a part of the document that is imprinted with machine-readable details is passed through a slot in a scanner is made considerably more difficult, or even impossible, if the position of the machine-readable details relative to the edge of the document varies too much.

It is an object of the invention to create a method and a device which make it possible for details which are not only machine-readable, but also readable by the naked eye, to be imprinted in high density into a document, in particular a document in notebook form such as a passport.

### SUMMARY OF THE INVENTION

This object is attained by a method and by a device for performing the method as described herein. Because at least one first detail is printed in into a first field whose position is defined relative to two edges of the document, mutilation of the detail is precluded, and furthermore, good machine readability of the first detail is assured, since a machine reading system can ascertain the position of this detail quickly and simply, from the position of the easily identified edges of the document. Conversely, at least one second detail is printed into a second field whose position is defined relative to a graphic element detected in the document, so that unwanted overprinting of a second detail of this kind with the graphic element detected, or some other graphic element, can be precluded. A field in the document that is to be imprinted with a second detail can therefore be made small, and thus a large amount of information can be printed into a small area.

Official documents such as passports are generally numbered serially or provided in some other way with a specific piece of information for each individual document of its kind, which makes it possible to identify the document even before any bearer-specific details have been entered into the document. To make this information individualizing and uniquely identifying of the document as tamper-proof as possible, the individualizing information can be formed in particular by a perforation pattern. Since such a pattern is hard for a human official to read, it is expedient for the sake of processing the documents if the finished document is provided with the same individualizing information in imprinted form as well. To generate this printing during the production of the blank documents requires one additional operation, which increases the costs for the blank documents. A refinement of the method according to the invention makes it possible to dispense with this operation, by reading the individualizing information from the document and then printing the information back into the document. Since a camera which is needed anyway for detecting an edge and/or a graphic element of the document can be used for reading the individualizing information, and because the printing of the individualizing information can be done jointly with the printing of the user-specific details, printing the information that individualizes the document does not entail any significant costs.

As already noted, the first detail can expediently be printed in a machine-readable form. To make the machine reading easier, or more specifically to make it easier for a scanner or other machine reader to find the detail, the first detail can expediently be printed in such a way that it is flanked by filler characters.

Preferably, the feeding of the document to be imprinted is done in conjunction with the detection of the two edges, and a first edge of the document that is substantially perpendicular to the feeding direction is detected during the feeding, for instance with the aid of a simple sensor that is stationary with respect to a conveyor; then the document and the print head can be positioned correctly relative to one another in this feeding direction by simply feeding the document onward by a predetermined distance, after the first edge is detected.

To detect the second edge and position the print head relative to it, in a first step, a two-dimensional image of the document is preferably generated, and the second edge is detected in this image.

If desired, the image can also be used to detect the first edge in the image and to position the document and the print head perpendicular to that edge relative to one another.

A device for performing the method of the invention includes at least one camera for generating an image of the document, but preferably at least two cameras, which are oriented so as to detect various portions of the document. For instance, one camera can be aimed at a desired position of the two edges to be detected, while the other camera is aimed at a desired position of the graphic characteristic to be detected. The image detection can thus remain limited to a small portion of the surface of the document, so that the quantity of image data that has to be processed is kept small. Moreover, the camera resolution required to attain a given positioning accuracy of the print head relative to the document is so much lesser, the smaller the selected portions are at which the cameras are aimed. Therefore, without losing positioning accuracy, two inexpensive cameras with a low number of pixels can replace a single, considerably more expensive, camera that has a number of pixels that is multiple times higher. Since the fields of view of the two cameras can be small, these cameras can be placed close to the document to be imprinted, without requiring complicated imaging optics, and thus the device can be kept compact.

If the information to be read that individualizes or uniquely identifies the document to be imprinted is printed with an ink that is visible under ultraviolet light, then the device expediently includes a UV source for illuminating the field of view of at least one camera, so as to render the individualizing information visible.

The device can furthermore be equipped with a radio interface, which makes it possible for at least some of the information to be imprinted into the document, or information having the same meaning, to be transmitted in wireless fashion to a data medium, such as a diskette, compact disc, tape, or memory chip, in the document to be imprinted.

The print head of the device is preferably a piezoelectrically operated inkjet print head. This print head functions at lower temperatures, for instance, as a thermoelectrically operated print head and therefore makes it possible to use pigment inks that are resistant to ultraviolet radiation.

Further characteristics and advantages of the invention will become apparent from the ensuing description of exemplary embodiments in conjunction with the accompanying drawings.

### BRIEF DESCRIPTION OF THE DRAWINGS

FIG. 1 shows the page layout recommended by ICAO for a passport.

FIG. 2 shows a passport, opened up.

FIG. 3 shows a schematic top view of a device according to the invention for imprinting a passport.

FIG. 4 shows a schematic section through the device taken along the line IV-IV of FIG. 3.

FIG. 5 shows a side view of the device.

FIG. 6 shows a top view of the device, not showing the housing, at the instant when a leading edge of a passport to be imprinted is detected.

FIG. 7 shows the device during the imprinting of the passport.

### DETAILED DESCRIPTION OF THE PREFERRED EMBODIMENTS

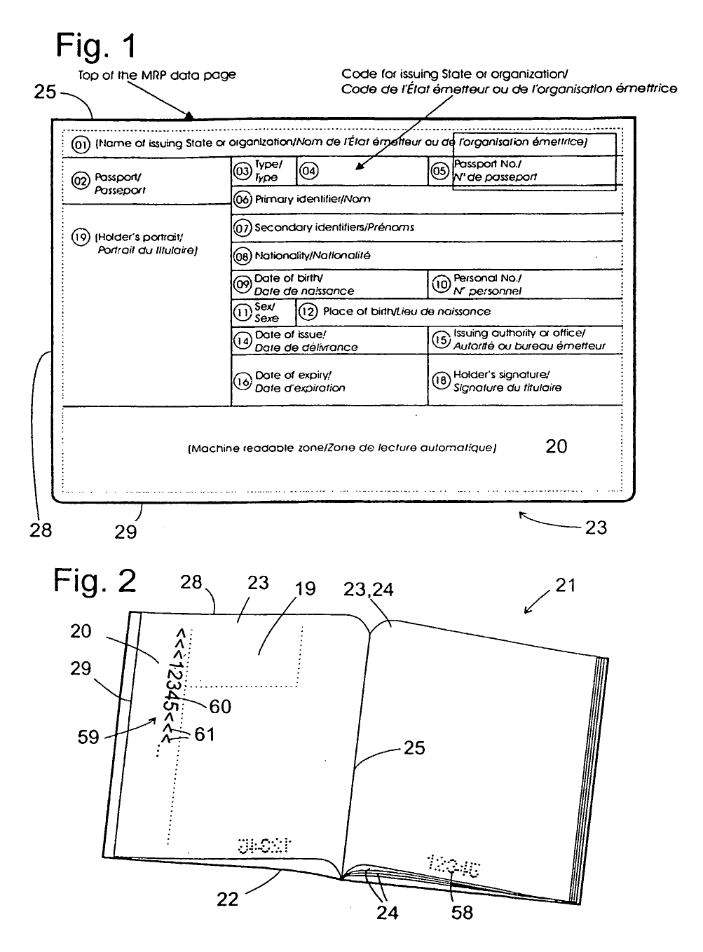

A passport (see FIG. 2) conventionally has the form of a notebook or small book 21 with a plurality of pages 23, 24, bound in a cover 22; whereas one or two of these pages 23 contain details, entered by the issuing agency, about the person of the bearer, while the other pages 24 are generally left available for visas. In accordance with a proposal by the International Civil Aviation Organization (ICAO), a uniform international format for passports shown in FIG. 1 is to be introduced in the future that is intended to make it easier to automate the checking of personal information about travelers of various nationalities in international travel. Accordingly, the details about the person of the passport bearer are summarized on a single page 23 and entered there, together with a passport number, in fields 01 through 19. The seam 25 binding the passport 21 together forms the upper edge of the page shown in FIG. 1; a machine-readable zone 20 is located on an outer edge of the page 23, away from the seam 25. Because of the placement of the machine-readable zone 20 at the edge of the page 23, it is possible to place the edge of the page 23 against a stop of an automatic scanner so that it can be read automatically.

In practice, unlike what is shown in FIG. 1, the fields 01 through 19 are not demarcated from one another by printed lines. Instead, each field is designated solely by a preprinted legend in its lower left corner; the text of the legend designates the type of details entered in that field, and the legend must not be overprinted with these details.

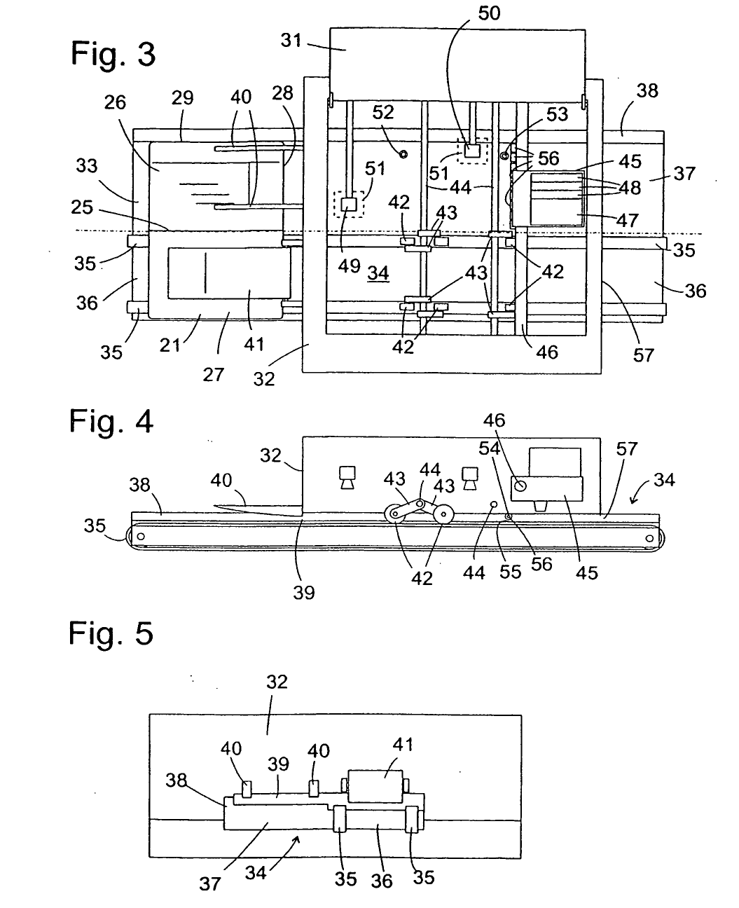

FIG. 3, in a schematic view, shows a printer for printing personal information in a passport. The printer has a housing 32, shown here with its lid 31 open. Protruding from the left-hand side of the housing 32 is a feed table 33 onto which a passport 21 to be imprinted can be placed. The feed table 33 is part of a carrier plate 34, which extends transversely through the housing 32 to a delivery opening 57 on its right-hand side. As can be seen particularly in the side view in FIG. 5, the carrier plate 34 includes a first plate portion 36, around which two conveyor belts 35 extend; a second plate portion 37, which extends parallel to the first plate portion 36 at a slightly higher level than the first; and a vertical strut 38. A front part 26 of the passport 21 to be imprinted, which includes the front half of the cover 22 and a page 23 to be imprinted (which may be either the inside front of the cover 26, or second page of the document, that is, the back side of the first sheet of the passport), rests on the second plate portion 37, and the side edge of the front half of the cover 22 touches the strut 38. The seam 25 that binds the passport together is located above the first plate portion 36, near the boundary with the second plate portion 37. A rear part 27, which includes all the other sheets of the passport 21 as well as the back half of the cover 26, rests on the conveyor belt 35 of the first plate portion 36. The difference in height between the plate portions 36, 37 is equal to the difference in thickness between the parts 26, 27 of the passport 21 that are located on the different plate portions, and it is thus possible in the further processing of the passport 21 to bring the two opened-up pages to the same height for printing.

Guide ribs 40 protrude from the housing 32 above an inlet opening 39; pages of the opened-up passport 21 that are not lying completely flat are gradually pressed flat by these ribs 40 while the passport 21 is being drawn into the housing 32 with the aid of the conveyor belts 35, so as to prevent damage to the passport at the inlet opening 39. The guide ribs 40 may be distributed over the entire width of the inlet opening 39; in the exemplary embodiment shown here, however, there are only two guide ribs 40 above the plate region 37 that is located higher than the other; above the plate portion 36, a radio antenna 41 is mounted pivotably on the housing 32 and serves to transmit data about the passport bearer to a semiconductor memory that is incorporated together with an antenna in the back half of the cover of the passport 21.

In the interior of the housing 32, a plurality of contact pressure rollers 42 are installed above each of the two conveyor belts 35; these rollers 42 are vertically movable and are pressed downward by a spring, not shown, in order to press the back part 27 of the passport 21, resting on the plate portion 36, against the conveyor belts 35 and thus to assure a precise linear feeding of the passport 21. In the exemplary embodiment shown, the contact-pressure rollers 42 are each pivotably connected via arms 43 to transverse rods 44 that extend transversely to the feeding direction, but still other ways of mounting them are also possible.

An inkjet print head 45 is displaceable transversely to the feeding direction in a manner known per se on a rail 46 and holds four ink cartridges: one black cartridge 47 and three color cartridges 48, which make it possible to print a color photo of the passport bearer into the passport.

Two cameras 49, 50 are mounted above the plate portion 37 in the housing 32 and observe a field of view 51, indicated by the outline drawn in dashed lines respectively, on the plate portion 37, upstream in terms of the feeding direction from the range of motion of the print head 45.

Between the two cameras in the feeding direction, an optical sensor 52 is located on the plate portion 37. The sensor 52 is preferably embodied as a photoelectric barrier, of which a light source located above the plate portion 37 has been omitted from the drawing, but a photo cell located in an opening in the plate portion 37 is visible.

When the printer is started up and the conveyor belts 35 begin to feed the passport 21, the leading edge 28 of the passport is detected by the photoelectric barrier 52 when it interrupts the light striking the photo cell. To enable exact detection of the leading edge 28, provision can be made that once this edge 28 has first moved past the sensor 52, the feeding direction of the conveyor belts 35′ is reversed at least once and the feeding speed is reduced, to enable the leading edge 28 to pass through the photoelectric barrier a second or a third time, in each case at a reduced speed, until the leading edge is placed at the sensor 52 with adequate precision.

Once this has taken place, the conveyor belts 35 are moved in the original feeding direction again by a predetermined distance, so that the leading edge 28 of the passport 21 comes to be within the field of view 51 of the camera 50 on the right. The image furnished by the camera 50 can be used to check the position of the leading edge 28 based on its location in this image; primarily, however, the camera 50 serves to detect a side edge 29 of the page that is to be imprinted. If the page to be imprinted is the inside cover of the passport 21, then the side edge 29 to be detected is usually located directly at the strut 38; however, if the page 23 to be imprinted is one side of an inside sheet of the passport, then its side edge 29, as can be seen in FIG. 2, might certainly have shifted relative to the edge of the cover 22. To detect the side edge 29 of the sheet to be imprinted, a processor (not shown) connected to the camera 50 checks whether, in addition to the edge necessarily included between the strut 38 and the plate portion 37, a further line parallel to that edge can be identified in the field of view 51. If not, it is assumed that the page to be imprinted is located exactly at the strut 38; otherwise, the other line detected is assumed to be the edge 29 of the page to be imprinted.

The processor may be a component of the printer itself, or it can belong to a host computer that supplies the printer with the data to be imprinted into the passport.

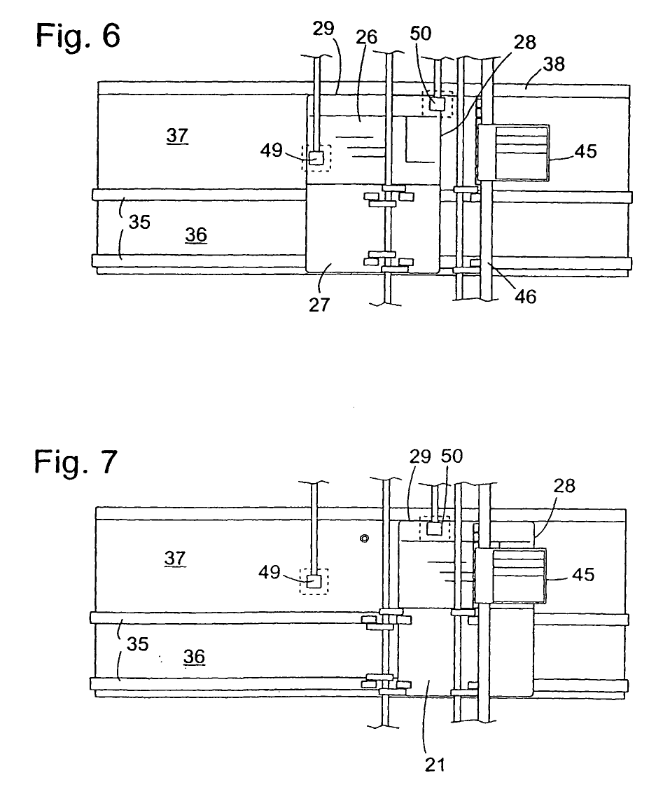

From the image furnished by the camera 50, the processor can estimate the position of the page to be imprinted in the printer exactly, but it cannot exactly estimate the position of the legends on that page, which depending on the precision with which the passport 21 is produced may vary by a few millimeters. For detecting such a legend, the camera 49 is provided. At least the field 05 of the passport 21, in which a serial number of the passport has already been entered by that time, is located in the field of view 51 of this camera 49 in the state shown in FIG. 6. The processor identifies the legend in the image furnished by the camera 49, and from the position of this legend position and from the known layout of the page 23, it identifies the exact position of all the imprintable regions of the fields 1-19. In addition, it identifies the characters of which the serial number of the passport is composed.

The passport 21 is now fed onward, as shown in FIG. 7, so that it is within the range of motion of the print head 45. In the process, the passport 21 moves away from the photoelectric barrier 52. Most inkjet printers, which are designed for printing single sheets, have a sensor connected to a printer controller, such as the sensor 52, for enabling the controller, before printing of a page begins, to position the leading edge of that page exactly with respect to the print head and to detect the end of the page in order to discontinue the printing, eject the page, and cause a new page to be fed in. If this kind of conventional controller were used as the processor of the printer according to the invention, then the passage of the trailing edge of the passport 21 past the sensor 52 would cause the passport to be ejected and would cause the attempt to be made to feed in a new passport. Since on the one hand the size of a passport is small, compared to a conventional DIN A4 sheet, and since on the other hand the spacing between the sensor 52 and the print head 45 has to be nearly as great as the requisite length of a page of the passport for placing the cameras 49, 50, printing of the passport would be possible on only a very small portion of the pages. To circumvent this problem and nevertheless be able to realize the printer according to the invention using inexpensive standard printer components as much as possible, a second sensor 53 is located along the feed path of the passport 21, shortly before the print head 45 is reached. The two sensors 52, 53 are both connected to a common signal input of the microprocessor via a logical OR gate, which signals the processor that printable paper is present, as long as at least one of the two sensors 52, 53 is detecting the passport 21. It is thus possible to continue printing into the passport until its trailing edge has moved past the sensor 53, or in other words to print over nearly the entire area of the page.

A rod 56 that turns a plurality of small, cylindrical rotatable rollers 54 is located between the sensor 53 and the range of motion of the print head 45, above the plate portion 37, transversely to the feeding direction. The rod is stationary, so that between the rollers 54 and the plate portion 37, there is a gap 55 through which the part 26 of the passport 21 located above the plate portion 37 passes with play. The page 23 of the opened passport 21 presses from below against the rollers 54, so that its underside defines the height of the surface to be imprinted of the passport. The rod 56 is expediently located at a height such that the top sides of both parts 26, 27 of the passport are located at precisely the same level. In printing, it is thus possible for the print head 45 to be made to move in a single motion over both halves of the passport, and to imprint both halves, line by line, simultaneously with the same quality, if printing of both pages is intended for the particular kind of passport involved.

With the knowledge of the position of the legend in field 05, obtained from the image from the camera 49, the processor calculates the position of the printable regions of all the fields 1-19 and causes the details that are meant to be entered in these fields to be printed when the print head moves past one of these regions. This assures that for the fields 1-19, which contain certain details intended to be seen by a person, such as the name and place of birth of the passport bearer, or his photograph, these details will always be printed in the correct place, properly oriented relative to the legend, but possibly at different spacings from the edges of the page from one passport to another. Conversely, in printing into the machine-readable zone 20, the position detected for the edges of the passport is used as a reference for positioning the imprint, so that the individual characters of the machine-readable details always appear in a fixed, replicable relationship in terms of the location relative to the edge of the printed surface. A machine reading system therefore needs at first only to detect the edges of the passport in order to decide precisely the places where machine-readable characters are located on the page 23. Because intentionally only those regions are examined in the character recognition, the machine reading of the passport can be simplified substantially and thus speeded up. The details 59 (see FIG. 2) printed in the machine-readable zone can include at least some of the details printed in fields 1-19, including the preprinted number 60 of the passport that has been identified in the image from the camera 49. Regions of the machine-readable zone 20 not needed for printing of details are filled with filler characters 61.

If the passports to be imprinted do not have a serial number in field 05, for instance because they are identifiable from a perforated serial number 58 or, if present, from individualizing information that is stored in the semiconductor memory in the cover and that can be read via the antenna 41, then one of the cameras 49, 50 can be suitably placed so that the perforation 58 falls within its field of view 51, or the individualizing information can be read with the aid of the antenna 41 and then entered by the printer itself into the field 05.

1. A method for printing details into a document, comprising:
a) detecting two intersecting edges of the document;
b) calculating the position of a first field, to be imprinted with a first detail, of the document from the position of the two detected intersecting edges;
c) positioning a print head at the first field to be imprinted and printing the first detail;
d) detecting a graphic element in the document;
e) calculating the position of a second field to be imprinted from the position of the graphic element detected;
f) positioning the print head at the second field to be imprinted, and printing a second detail.

2. The method as recited in claim 1, further comprising:
g) reading a piece of information from the document, wherein the piece of information uniquely identifies the document; and
h) printing the identifying information into the document.

3. The method as recited in claim 2, wherein in step g), a character recognition operation is performed on the identifying information, which is formed of alphanumeric characters, and in step h), the characters detected are printed, using a different form of the character from that of the character that has been read.

4. The method as recited in claim 2, wherein the identifying information read in step g) is a perforation pattern.

5. The method as recited in claim 2, wherein the identifying information read in step g) comprises printed alphanumeric characters, in particular alphanumeric characters printed with an ink that is visible only under UV light.

6. The method as recited in claim 1, wherein the first detail is printed in a machine-readable form.

7. The method as recited in claim 1, wherein the first detail is printed, flanked by filler characters.

8. The method as recited in claim 1, wherein the second detail is printed in a form that is readable by the naked eye.

9. The method as recited in claim 1, wherein in step a), the document is fed, and a first edge of the document which is substantially perpendicular to the feeding direction is detected during the feeding; and step c) includes the further feeding of the document by a predetermined distance in the feeding direction after the detection.

10. The method as recited in claim 1, wherein in step a), a two-dimensional image of the document is generated and in the image, at least one of the two edges is detected.

11. The method as recited in claim 1, wherein in step a), a differentiation is made between an edge of a cover of the document and an adjacent edge of a page of the document to be imprinted, and the edge of the page to be imprinted is used in step c) for positioning the print head and the document relative to one another.

12. A device for printing details into a document, comprising:
a moving print head;
at least one camera for detecting at least one edge of the document and of a graphic element in the document; and
a control unit for positioning the print head based on the detected edge and on the graphic element.

13. The device as recited in claim 12, comprising at least two cameras, which are oriented so as to detect various portions of the document.

14. The device as recited in claim 12, further comprising a conveyor for feeding documents to be imprinted into a printing region of the print head.

15. The device as recited in claim 14, further comprising a sensor disposed on the conveyor, wherein the sensor can detect an edge of the document that is oriented transversely to a feeding direction of the document.

16. The device as recited in claim 12, further comprising a UV source for illuminating the field of view of the at least one camera with ultraviolet light.

17. The device as recited in claim 12, further comprising a radio interface for wireless communication with a data medium in a document to be imprinted.

18. The device as recited in claim 12, wherein the print head is a piezoelectrically operated inkjet print head.
